(19) United States
(12) Patent Application Publication
(10) Pub. No.: US 2016/0063514 A1
(43) Pub. Date: Mar. 3, 2016

(54) MARKETING PLATFORM THAT PROVIDES ANONYMOUS AND COMPARATIVE PERFORMANCE INFORMATION RELATED TO VENDORS

(71) Applicant: Verizon Patent and Licensing Inc., Arlington, VA (US)

(72) Inventors: Ashok N. Srivastava, Mountain View, CA (US); Gaurav Goel, Los Gatos, CA (US); An Le, San Mateo, CA (US); Rebecca Nie, Palo Alto, CA (US)

(21) Appl. No.: 14/472,996

(22) Filed: Aug. 29, 2014

(51) Int. Cl. G06Q 30/02

(52) U.S. Cl. CPC G06Q 30/0201; G06Q 30/0246

(57) ABSTRACT

A device receives user information associated with users of user devices, and receives vendor information associated with vendors. The device identifies a performance metric for the vendors based on a request received from a particular vendor of the vendors, and determines performance information for the vendors based on the identified performance metric, the user information, and the vendor information. The device anonymizes the performance information for the vendors to produce anonymous performance information, without anonymizing the performance information for the particular vendor. The device generates a user interface that visually depicts the anonymous performance information and the performance information for the particular vendor, and provides the user interface to a device associated with the particular vendor.

### BACKGROUND

Users today utilize a variety of user devices, such as cell phones, smart phones, tablet computers, etc., to access online services (e.g., email applications, Internet services, television services, etc.), purchase products and/or services, and/or perform other tasks.

### BRIEF DESCRIPTION OF THE DRAWINGS

FIG. 1 is a diagram of an overview of an example implementation described herein;

FIG. 2 is a diagram of an example environment in which systems and/or methods described herein may be implemented;

FIG. 3 is a diagram of example components of one or more devices of FIG. 2;

FIG. 4 is a flow chart of an example process for providing anonymous and comparative performance information related to vendors; and

FIGS. 5A-5F are diagrams of an example relating to the example process shown in FIG. 4.

### DETAILED DESCRIPTION OF PREFERRED EMBODIMENTS

The following detailed description refers to the accompanying drawings. The same reference numbers in different drawings may identify the same or similar elements.

Information associated with user devices (e.g., locations of the user devices when tasks are performed, times associated with when the user devices perform the tasks, network resources utilized by the user devices, etc.) and information associated with content accessed by the user devices (e.g., clickstream information associated with the user devices) may be collected by a provider of a network. Information associated with the users (e.g., preferences and other information) may be shared with vendors (e.g., businesses, organizations, etc.) that provide such products and/or services so that the users can access and interact with the vendors in an efficient manner.

Vendors are constantly trying to find out as much about users as possible so that the vendors can market appropriate products and/or services to the users via advertisements (ads). However, most vendors know very little about the users of their products and/or services. The vendors may utilize multiple marketing channels (e.g., online advertisements, email advertisements, television advertisements, etc.) to provide the advertisements to the users. Thus, the vendors are also constantly trying to figure out how to allocate a marketing budget so that appropriate advertisements are provided to appropriate users at appropriate times and via appropriate marketing channels.

A particular vendor may try to compare vendor performance information (e.g., sales of products and/or services, effectiveness of advertising campaigns, web site traffic, etc.) with performance information associated with other peer vendors in a same industry as the particular vendor. For example, a running shoe retailer may try to compare the running shoe retailer's performance information with performance information associated with other running shoe retailers. However, most vendors have no way of comparing the vendors' performance information with performance information of peer vendors.

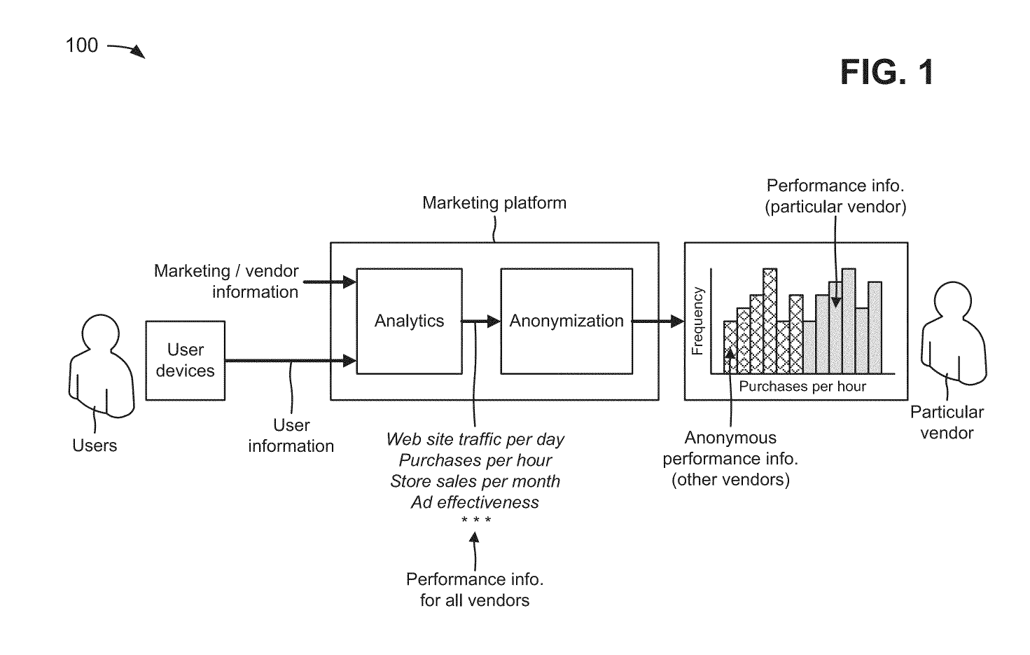

FIG. 1 is a diagram of an overview of an example implementation 100 described herein. In example implementation 100, assume that a marketing platform is associated with multiple user devices and corresponding users. The marketing platform may receive user information from the user devices, and may receive marketing/vendor information from other sources. The user information may be generated by the multiple user devices, and may include information associated with the user devices and the users, network information, time information, location information, etc. The user information may be stored in the user devices and/or in a network resource (e.g., a server device), and provided to the marketing platform. The marketing/vendor information may include information associated with products and/or services offered by vendors and to be marketed to the users, advertisements for the products and/or the services, vendor names, etc.

The marketing platform may include an analytics component and an anonymization component. The analytics component may identify performance metrics for the vendors based on the user information and the marketing/vendor information. For example, the analytics component may identify web site traffic per day, purchases per hour, store sales per month, advertisement effectiveness, etc. as performance metrics associated with the vendors. The analytics component may determine performance information for all of the vendors (e.g., in a particular industry) based on the user information, the marketing/vendor information, and the identified performance metrics. The performance information may include, for example, web site traffic per day for each of the vendors, purchases per hour for each of the vendors, store sales per month for each of the vendors, advertisement effectiveness for each of the vendors, etc. As further shown in FIG. 1, the analytics component may provide the performance information to the anonymization component.

The anonymization component may anonymize the performance information associated with all of the vendors except the performance information associated with a particular vendor (e.g., a vendor that subscribes to services provided by the marketing platform). For example, assume that a particular vendor is a clothing retailer that wants to compare the particular vendor's performance information with performance information of other clothing retailers. In such an example, anonymization component may anonymize the performance information of the other clothing retailers (e.g., by removing information identifying the other clothing retailers) so that the other clothing retailers information is protected. The anonymization component may store the anonymous performance information and the performance information associated with the particular vendor.

As further shown in FIG. 1, the anonymization component may provide, for display to the particular vendor, the anonymous performance information and the performance information associated with the particular vendor. For example, the anonymous performance information may include information identifying a frequency of purchases per hour (e.g., of products and/or services) by the users and from the other vendors. The performance information may include information identifying a frequency of purchases per hour by the users and from the particular vendor. The anonymous performance information may be compared with the performance information so that the particular vendor may determine how the particular vendor is performing in comparison with the other vendors.

Systems and/or methods described herein may provide a marketing platform that provides anonymous performance information related to peer vendors, and compares the anonymous performance information with actual performance information for a particular vendor. The systems and/or methods may ensure that information identifying the peer vendors of the particular vendor is protected and not shared with the particular vendor. The systems and/or methods may enable the particular vendor to determine how the particular vendor is performing in comparison with the peer vendors.

As used herein, the term user is intended to be broadly interpreted to include a user device, or a user of a user device. The term vendor, as used herein, is intended to be broadly interpreted to include a business, an organization, a government agency, a vendor device, a user of a vendor device, etc.

A product, as the term is used herein, is to be broadly interpreted to include anything that may be marketed or sold as a commodity or a good. For example, a product may include bread, coffee, bottled water, milk, soft drinks, pet food, beer, fuel, meat, fruit, automobiles, clothing, content, etc. The term content, as used herein, is to be broadly interpreted to include video, audio, images, text, software downloads, and/or combinations of video, audio, images, text, and software downloads.

A service, as the term is used herein, is to be broadly interpreted to include any act or variety of work done for others (e.g., for compensation). For example, a service may include a repair service (e.g., for a product), a warranty (e.g., for a product), a telecommunication service (e.g., a telephone service, an Internet service, a network service, a radio service, a television service, a video service, etc.), an automobile service (e.g., for selling automobiles), a food service (e.g., a restaurant), a banking service, a lodging service (e.g., a hotel), etc.

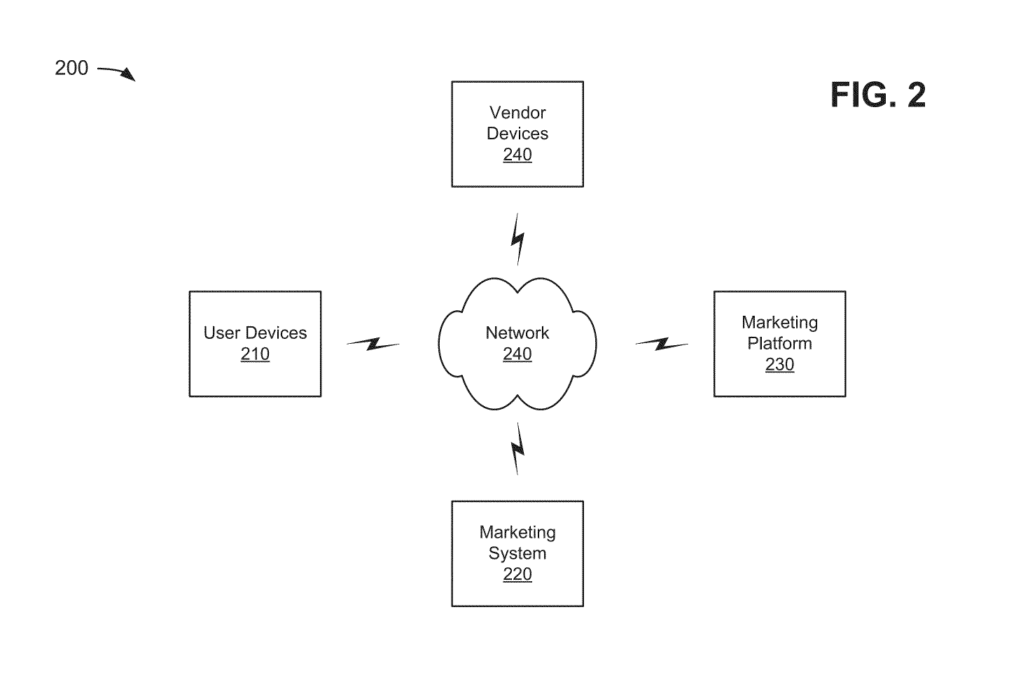

FIG. 2 is a diagram of an example environment 200 in which systems and/or methods described herein may be implemented. As illustrated, environment 200 may include user devices 210, a marketing system 220, a marketing platform 230, vendor devices 240, and a network 250. Devices/networks of environment 200 may interconnect via wired connections, wireless connections, or a combination of wired and wireless connections.

User device 210 may include a device that is capable of communicating over network 250 with marketing system 220, marketing platform 230, and/or vendor devices 240. In some implementations, user device 210 may include a radiotelephone; a personal communications services (PCS) terminal that may combine, for example, a cellular radiotelephone with data processing and data communications capabilities; a smart phone; a configured television; a personal digital assistant (PDA) that can include a radiotelephone, a pager, Internet/intranet access, etc.; a laptop computer; a tablet computer; a global positioning system (GPS) device; a gaming device; a set-top box (STB); or another type of computation and communication device. In some implementations, user device 210 may be associated with a service provider that manages and/or operates network 250, such as, for example, a telecommunication service provider, a television service provider, an Internet service provider, a wireless service provider, etc.

Marketing system 220 may include one or more personal computers, one or more workstation computers, one or more server devices, one or more virtual machines (VMs) provided in a cloud computing network, and/or one or more other types of computation and communication devices. In some implementations, marketing system 220 may be associated with one or more vendors or other entities that provide marketing services for the vendors. In some implementations, marketing system 220 may enable vendors (e.g., associated with vendor devices 240) to generate marketing/vendor information, and to provide the marketing/vendor information to user devices 210, marketing platform 230, and/or vendor devices 240. The marketing/vendor information may include information associated with products and/or services offered by the vendors and to be marketed to the users; advertisements for the products and/or the services offered by the vendors; marketing campaign information (e.g., a campaign for a particular product and/or service, a marketing budget for the campaign, timing associated with the campaign, etc.); interactions (e.g., transactions, creation of user accounts with the vendors, creation of user profiles with the vendors, etc.) between the vendors and the users (e.g., between marketing system 220 and user devices 210); etc.

Marketing platform 230 may include one or more personal computers, one or more workstation computers, one or more server devices, one or more VMs provided in a cloud computing network, and/or one or more other types of computation and communication devices. In some implementations, marketing platform 230 may be associated with a service provider that manages and/or operates network 250, such as, for example, a telecommunication service provider, a television service provider, an Internet service provider, a wireless service provider, etc.

In some implementations, marketing platform 230 may receive user information associated with users of network 250, and may receive marketing/vendor information associated with products and/or services offered by vendors and/or marketed by marketing system 220. Marketing platform 230 may identify performance metrics based on the received information, and may determine performance information for the vendors based on the user information, the marketing/vendor information, and the identified performance metrics. Marketing platform 230 may anonymize the performance information for all of the vendors without anonymizing the performance information for a particular vendor, and may store the anonymous performance information and the performance information for the particular vendor. Marketing platform 230 may provide, for display to the particular vendor, the anonymous performance information compared to the performance information for the particular vendor.

Vendor device 240 may include a device that is capable of communicating over network 250 with user devices 210, marketing system 220, and/or marketing platform 230. In some implementations, vendor device 240 may include a personal computer; a workstation computer; a server device; a VM provided in a cloud computing network; a radiotelephone; a PCS terminal that may combine, for example, a cellular radiotelephone with data processing and data communications capabilities; a smart phone; a configured television; a PDA that can include a radiotelephone, a pager, Internet/intranet access, etc.; a laptop computer; a tablet computer; a GPS device; a gaming device; a STB; or another type of computation and communication device. In some implementations, vendor device 240 may be associated with a vendor of one or more products and/or services.

Network 250 may include a network, such as a local area network (LAN), a wide area network (WAN), a metropolitan area network (MAN), a telephone network, such as the Public Switched Telephone Network (PSTN) or a cellular network, an intranet, the Internet, a fiber optic network, a satellite network, a cloud computing network, or a combination of networks. In some implementations, network 250 may be associated with a service provider (e.g., and be referred to as a service provider network) that manages and/or operates network 250, such as, for example, a telecommunication service provider, a television service provider, an Internet service provider, a wireless service provider, etc.

In some implementations, the cellular network may include a fourth generation (4G) cellular network that includes an evolved packet system (EPS). The EPS may include a radio access network (e.g., referred to as a long term evolution (LTE) network), a wireless core network (e.g., referred to as an evolved packet core (EPC) network), an Internet protocol (IP) multimedia subsystem (IMS) network, and a packet data network (PDN). The LTE network may be referred to as an evolved universal terrestrial radio access network (E-UTRAN), and may include one or more base stations. The EPC network may include an all-Internet protocol (IP) packet-switched core network that supports high-speed wireless and wireline broadband access technologies. The EPC network may allow user devices 210 to access various services by connecting to the LTE network, an evolved high rate packet data (eHRPD) radio access network (RAN), and/or a wireless local area network (WLAN) RAN. The IMS network may include an architectural framework or network (e.g., a telecommunications network) for delivering IP multimedia services. The PDN may include a communications network that is based on packet switching. In some implementations, the cellular network may provide location information (e.g., latitude and longitude coordinates) associated with user devices 210. For example, the cellular network may determine a location of user device 210 based on triangulation of signals, generated by user device 210 and received by multiple base stations, with prior knowledge of the base stations.

In some implementations, the satellite network may include a space-based satellite navigation system (e.g., a global positioning system (GPS)) that provides location and/or time information in all weather conditions, anywhere on or near the Earth where there is an unobstructed line of sight to four or more satellites (e.g., GPS satellites). In some implementations, the satellite network may provide location information (e.g., GPS coordinates) associated with user devices 210, enable communication with user devices 210, etc.

The number of devices and/or networks shown in FIG. 2 is provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, one or more of the devices of environment 200 may perform one or more functions described as being performed by another one or more devices of environment 200.

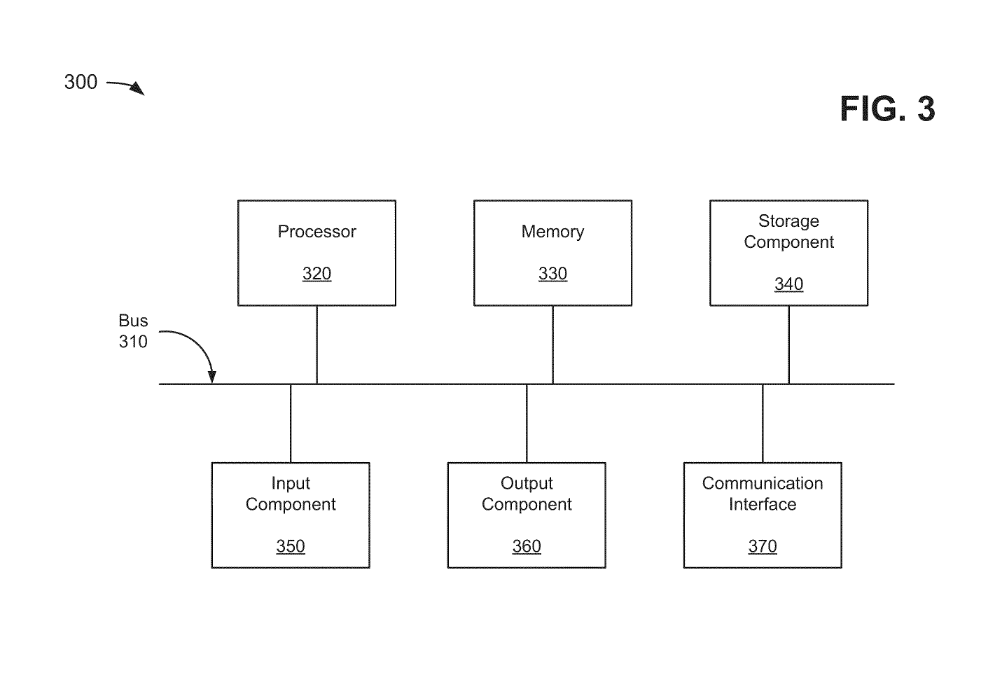

FIG. 3 is a diagram of example components of a device 300 that may correspond to one or more of the devices of environment 200. In some implementations, each of the devices of environment 200 may include one or more devices 300 or one or more components of device 300. As shown in FIG. 3, device 300 may include a bus 310, a processor 320, a memory 330, a storage component 340, an input component 350, an output component 360, and a communication interface 370.

Bus 310 may include a component that permits communication among the components of device 300. Processor 320 may include a processor (e.g., a central processing unit (CPU), a graphics processing unit (GPU), an accelerated processing unit (APU), etc.), a microprocessor, and/or any processing component (e.g., a field-programmable gate array (FPGA), an application-specific integrated circuit (ASIC), etc.) that interprets and/or executes instructions. Memory 330 may include a random access memory (RAM), a read only memory (ROM), and/or another type of dynamic or static storage device (e.g., a flash memory, a magnetic memory, an optical memory, etc.) that stores information and/or instructions for use by processor 320.

Storage component 340 may store information and/or software related to the operation and use of device 300. For example, storage component 340 may include a hard disk (e.g., a magnetic disk, an optical disk, a magneto-optic disk, a solid state disk, etc.), a compact disc (CD), a digital versatile disc (DVD), a floppy disk, a cartridge, a magnetic tape, and/or another type of computer-readable medium, along with a corresponding drive.

Input component 350 may include a component that permits device 300 to receive information, such as via user input (e.g., a touch screen display, a keyboard, a keypad, a mouse, a button, a switch, a microphone, etc.). Additionally, or alternatively, input component 350 may include a sensor for sensing information (e.g., a global positioning system (GPS) component, an accelerometer, a gyroscope, an actuator, etc.). Output component 360 may include a component that provides output information from device 300 (e.g., a display, a speaker, one or more light-emitting diodes (LEDs), etc.).

Communication interface 370 may include a transceiver-like component (e.g., a transceiver, a separate receiver and transmitter, etc.) that enables device 300 to communicate with other devices, such as via a wired connection, a wireless connection, or a combination of wired and wireless connections. Communication interface 370 may permit device 300 to receive information from another device and/or provide information to another device. For example, communication interface 370 may include an Ethernet interface, an optical interface, a coaxial interface, an infrared interface, a radio frequency (RF) interface, a universal serial bus (USB) interface, a Wi-Fi interface, a cellular network interface, or the like.

Device 300 may perform one or more processes described herein. Device 300 may perform these processes in response to processor 320 executing software instructions stored by a computer-readable medium, such as memory 330 and/or storage component 340. A computer-readable medium is defined herein as a non-transitory memory device. A memory device includes memory space within a single physical storage device or memory space spread across multiple physical storage devices.

Software instructions may be read into memory 330 and/or storage component 340 from another computer-readable medium or from another device via communication interface 370. When executed, software instructions stored in memory 330 and/or storage component 340 may cause processor 320 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 3 is provided as an example. In practice, device 300 may include additional components, fewer components, different components, or differently arranged components than those shown in FIG. 3. Additionally, or alternatively, a set of components (e.g., one or more components) of device 300 may perform one or more functions described as being performed by another set of components of device 300.

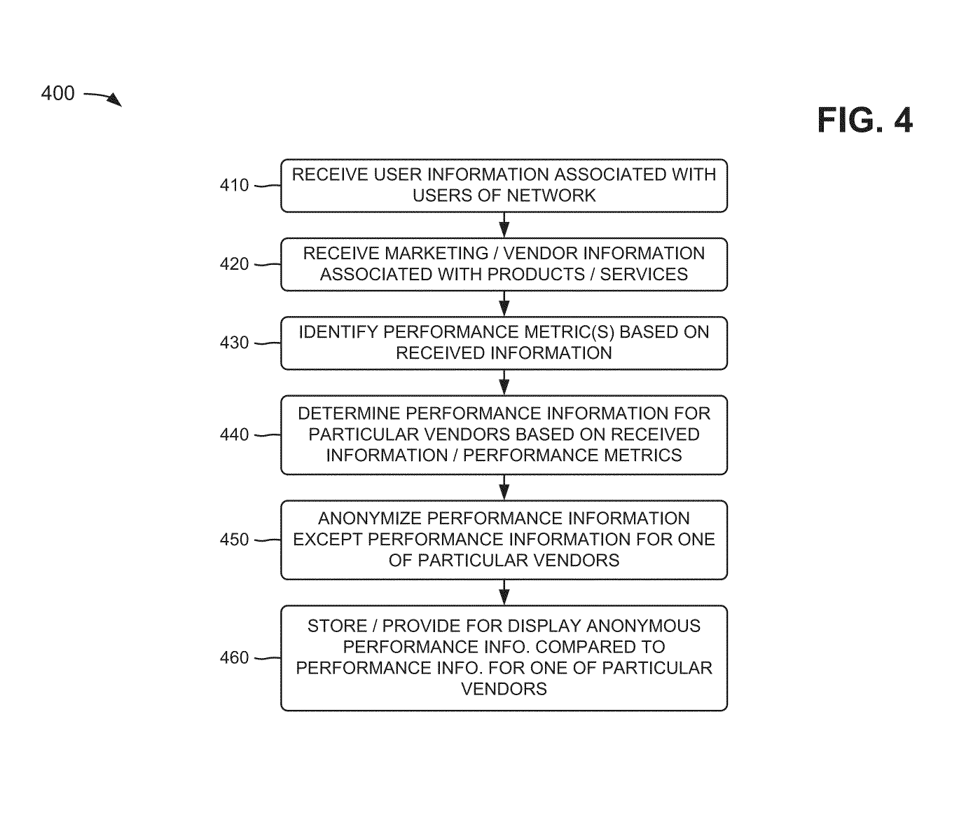

FIG. 4 is a flow chart of an example process 400 for providing anonymous and comparative performance information related to vendors. In some implementations, one or more process blocks of FIG. 4 may be performed by marketing platform 230. In some implementations, one or more process blocks of FIG. 4 may be performed by another device or a group of devices separate from or including marketing platform 230, such as user device 210 and/or marketing system 220.

As shown in FIG. 4, process 400 may include receiving user information associated with users of a network (block 410). For example, marketing platform 230 may receive, from user devices 210, user information associated with users of network 250. In some implementations, the user information may include information associated with user devices 210 (e.g., types of user devices 210, model numbers of user devices 210, etc.); information associated with the users of user devices 210 (e.g., account information, demographic information, etc.); network information (e.g., information associated with network resources of network 250 utilized by user devices 210); usage information associated with network 250 by user devices 210; content accessed by user devices 210; transactions associated with user devices 210; clickstream information associated with user devices 210; location information associated with user devices 210; time information associated with user devices 210; etc.

The clickstream information may include information associated with portions of user interfaces that users select (e.g., or click on) while web browsing (e.g., accessing content) or while using a software application. The location information may include information associated with locations (e.g., global positioning system (GPS) coordinates, cellular triangulation locations, etc.) of user devices 210 when content is accessed by user devices 210. In some implementations, the location information may include information associated with a current location of user device 210, proximity of user device 210 to something (e.g., another user device 210, a store, etc.), travel patterns of user device 210 (e.g., stops at a particular coffee shop on his way to work each day, drives home from work at 6:00 PM, a route traveled by user device 210, etc.), travel information (e.g., relating to an upcoming trip), a current location of another user device 210 (e.g., of a family member), etc. The time information may include information associated with times when user devices 210 access the content (e.g., dates and times when the content is accessed, an amount of time the user devices are performing online activities, such as browsing, etc.). In some implementations, the time information may include information associated with holidays, birthday(s), meetings, time of day, time of a week, etc.

In some implementations, user devices 210 may receive user information from users when the users register user devices 210 for a service (e.g., a telephone service, an Internet service, a television service, etc.), and such user information may include registration information, such as names, home addresses, contact information, account types, demographic information, gender information, etc. In some implementations, marketing platform 230 may continuously receive the user information from user devices 210 and/or network 250. In some implementations, marketing platform 230 may periodically (e.g., hourly, daily, weekly, etc.) receive the user information from user devices 210 and/or network 250. In some implementations, the user information may be stored in user devices 210 and/or in a network resource (e.g., a server device) of network 250, and continuously and/or periodically provided to marketing platform 230.

In some implementations, user device 210 may include an application that monitors, with the user's approval, actions taken in relation to user device 210. The application, on user device 210, may continuously transmit the monitored information (e.g., the user information and information identifying the user) to marketing platform 230, or may cause user device 210 to store the monitored information and provide the monitored information when requested by marketing platform 230 (e.g., during times when traffic of network 250 is low).

As further shown in FIG. 4, process 400 may include receiving marketing/vendor information associated with products and/or services (block 420). For example, marketing platform 230 may receive marketing/vendor information from marketing system 220. The marketing/vendor information may include information associated with products and/or services offered by vendors and to be marketed to the users; advertisements for the products and/or the services offered by the vendors; marketing campaign information (e.g., a campaign for products and/or services, a marketing budget for the campaign, timing associated with the campaign, etc.); user information received by the vendors via interactions between the vendors and the users; information identifying the vendors (e.g., names of the vendors, account information of the vendors, addresses of web sites associated with the vendors, etc.); etc.

As further shown in FIG. 4, process 400 may include identifying one or more performance metrics based on the received information (block 430). For example, marketing platform 230 may identify performance metrics, for the vendors, based on the user information and/or the marketing/vendor information. In some implementations, a performance metric may include information that determines and measures a vendor's behavior, activities, performance, etc. In some implementations, a performance metric may include a finance-based metric (e.g., sales, turnover, profit indicators, performance against budget, etc.), a metric that identifies performance against customer requirements, a metric that identifies value, etc. For example, a performance metric may include web site traffic (e.g., a number of hits) per a time period (e.g., hour, day, week, etc.); online purchases of products and/or services per a time period; store purchases of products and/or services per a time period; effectiveness of an advertisement (e.g., purchases of products and/or services associated with an advertisement, user feedback associated with an advertisement, etc.); etc.

In some implementations, marketing platform 230 may identify the performance metrics based on the user information. For example, users of user devices 210 may access web sites associated with the vendors (e.g., generating web site hits); may purchase products and/or services from the vendors via the web sites; may purchase products and/or services from stores associated with the vendors and via user devices 210 (e.g., at point-of-sale terminals in the store); may receive advertisements; may purchase products/services associated with the advertisements; may visit web pages relating to the advertisements; may request that the advertisements not be provided in the future; etc. Such information may be identified as performance metrics by marketing platform 230.

Alternatively, or additionally, marketing platform 230 may identify performance metrics based on the marketing/vendor information. For example, marketing system 220 may track information associated with sales of products and/or services offered by the vendors to the users; advertisements for the products and/or the services offered by the vendors; marketing campaign information; user information received by the vendors via interactions (e.g., web site access, receipt of advertisements, access of web pages relating to advertisements, etc.) between the vendors and the users; etc. Such information may be identified as performance metrics by marketing platform 230.

In some implementations, marketing platform 230 may identify the performance metrics based on a request from a particular vendor. For example, a particular vendor may provide, to marketing platform 230, a request that includes a performance metric to be utilized by marketing platform 230 to determine performance information. Marketing platform 230 may determine performance information (e.g., from the user information) based on the performance metric provided by the particular vendor.

As further shown in FIG. 4, process 400 may include determining performance information for particular vendors based on the received information and the performance metrics (block 440). For example, marketing platform 230 may determine performance information for particular vendors in a particular industry (e.g., retailers, banks, pharmaceutical companies, etc.) based on the user information, the marketing/vendor information, and/or the performance metrics. In some implementations, the performance information may include financial information associated with the particular vendors (e.g., sales, turnover, profit indicators, performance against budget, etc.); web site traffic (e.g., a number of hits) per a time period (e.g., hour, day, week, etc.) for web sites associated with the particular vendors; online purchases of products and/or services, offered by the particular vendors, per a time period; store purchases of products and/or services, offered by the particular vendors, per a time period; effectiveness of advertisements associated with the particular vendors; etc.

For example, assume that marketing platform 230 identifies web site traffic per day as a performance metric, and identifies sporting goods stores as the particular vendors. In such an example, marketing platform 230 may analyze the user information, and may identify (e.g., from the user information) clickstream information associated with the users of user devices 210 and the sporting goods stores. Marketing platform 230 may utilize the clickstream information to determine web site traffic per day for web sites associated with the sporting goods stores. Marketing platform 230 may also analyze the marketing/vendor information received from marketing system 220, and may identify (e.g., from the marketing/vendor information) additional clickstream information associated with third party users (e.g., users not associated with marketing platform 230) and the sporting goods stores. Marketing platform 230 may utilize the additional clickstream information to determine web site traffic per day for web sites associated with the sporting goods stores.

In another example, assume that marketing platform 230 identifies online purchases per hour as a performance metric, and identifies electronic products retailers as the particular vendors. In such an example, marketing platform 230 may analyze the user information, and may identify (e.g., from the user information) clickstream information and transaction information associated with the users of user devices 210 and the electronic products retailers. Marketing platform 230 may utilize the clickstream information and the transaction information to determine online purchases per hour for the electronic products retailers. Marketing platform 230 may also analyze the marketing/vendor information received from marketing system 220, and may identify (e.g., from the marketing/vendor information) additional clickstream information and transaction information associated with third party users and the electronic products retailers. Marketing platform 230 may utilize the additional clickstream information and transaction information to determine online purchases per hour for the electronic products retailers.

In yet another example, assume that marketing platform 230 identifies store purchases per day as a performance metric, and identifies clothing retailers as the particular vendors. In such an example, marketing platform 230 may analyze the user information, and may identify (e.g., from the user information) time information, location information (e.g., identifying locations of the stores of the clothing retailers), and transaction information associated with the users of user devices 210 and the clothing retailers. Marketing platform 230 may utilize the time information, the location information, and/or the transaction information to determine store purchases per day for the clothing retailers. Marketing platform 230 may also analyze the marketing/vendor information received from marketing system 220, and may identify (e.g., from the marketing/vendor information) additional time information, location information, and transaction information associated with third party users and the clothing retailers. Marketing platform 230 may utilize the additional time information, location information, and/or transaction information to determine store purchases per day for the clothing retailers.

In some implementations, marketing platform 230 may determine the performance information for the particular vendors based on the user information, and may determine the performance information for the one particular vendor based on the marketing/vendor information and/or the user information (e.g. when the one particular vendor subscribes to services provided by marketing platform 230).

As further shown in FIG. 4, process 400 may include anonymizing the performance information except for the performance information for one of the particular vendors (block 450). For example, marketing platform 230 may receive, from one of the particular vendors in the particular industry, a request for a comparison of the performance information for the particular vendors with the performance information for the one particular vendor. In some implementations, marketing platform 230 may anonymize the performance information for the particular vendors by removing information identifying the particular vendors from the performance information. For example, marketing platform 230 may remove names of the particular vendors, account information of the particular vendors, addresses of web sites associated with the particular vendors, etc. from the performance information for the particular vendors. In some implementations, marketing platform 230 may not remove information identifying the one particular vendor from the performance information for the one particular vendor since the one particular vendor requested the comparison.

In some implementations, marketing platform 230 may anonymize the performance information for the particular vendors by removing, from the performance information, any information which, in conjunction with other information available to the one particular vendor, could identify the particular vendors. In some implementations, marketing platform 230 may utilize data anonymization techniques to anonymize the performance information for the particular vendors. The data anonymization techniques may include, for example, data encryption, substitution, shuffling, nulling out, etc. Data encryption may include an anonymization technique that replaces sensitive data with encrypted data (e.g., transforms the sensitive data into an unreadable format). Substitution may include replacing contents of a database column with data from a predefined list of fictitious but similar data types so the data cannot be traced to the particular vendors. Shuffling may be similar to substitution, except that the anonymized data may be derived from the database column. Nulling out may include removing sensitive data by deleting the sensitive data from a shared data set.

As shown in FIG. 4, process 400 may include storing and/or providing for display the anonymous performance information compared to the performance information for the one of the particular vendors (block 460). For example, marketing platform 230 may store the anonymous performance information for the particular vendors and the performance information for the one particular vendor in storage (e.g., memory 330 and/or storage component 340, FIG. 3) associated with marketing platform 230. In some implementations, marketing platform 230 may provide the anonymous performance information for the particular vendors and the performance information for the one particular vendor for display to vendor device 240 associated with the one particular vendor. For example, the one particular vendor (e.g., via vendor device 240) may provide the request for the comparison of the performance information to marketing platform 230, and marketing platform 230 may provide the anonymous performance information for the particular vendors and the performance information for the one particular vendor for display by vendor device 240 based on the request.

In some implementations, marketing platform 230 may provide, for display, the anonymous performance information in comparison to the performance information for the one particular vendor. For example, assume that marketing platform 230 identifies web site traffic per hour as a performance metric, and identifies banks as the particular vendors. In such an example, marketing platform 230 may receive, from a particular bank (e.g., Bank A) a request for a comparison of the banks' performance information with performance information of Bank A. Based on the request, marketing platform 230 may provide, for display, web site traffic per hour for the banks (e.g., without identifying the banks) and web site traffic per hour for Bank A so that Bank A may determine how Bank A's web site is performing compared to the banks' web sites.

In another example, assume that marketing platform 230 identifies online purchases of products and/or services per hour as a performance metric, and identifies shoe retailers as the particular vendors. In such an example, marketing platform 230 may receive, from a particular shoe retailer (e.g., Shoe Retailer A) a request for a comparison of the shoe retailers' performance information with performance information of Shoe Retailer A. Based on the request, marketing platform 230 may provide, for display, online purchases per hour for the shoe retailers (e.g., without identifying the shoe retailers) and online purchases per hour for Shoe Retailer A so that Shoe Retailer A may determine how the online sales of Shoe Retailer A are performing compared to the online sales of the shoe retailers.

In some implementations, marketing platform 230 may provide, for display, the comparison of the anonymous performance information with the performance information for the one particular vendor in a textual format (e.g., in a table, a chart, etc.), a graphical format (e.g., a bar chart, a histogram, a pie chart, etc.), and/or a combination of textual and graphical formats. In some implementations, marketing platform 230 may perform mathematical operations on the anonymous performance information, and may provide, for display, a comparison of the results of the mathematical operations with the performance information for the one particular vendor. For example, marketing platform 230 may calculate an average, a median, a mean, a normal distribution, etc. of the anonymous performance information, and may provide, for display, a comparison of the average, the median, the mean, the normal distribution, etc. with the performance information for the one particular vendor.

In some implementations, marketing platform 230 may delete anonymous performance information that is not relevant to the performance information for the one particular vendor. For example, assume that marketing platform 230 determines (e.g., from the location information associated with user devices 210) a number of store visits per day for clothing retailers A, B, C, D, and E (e.g., where clothing retailer A is the one particular vendor) to be 20, 35, 30, 1, and 25, respectively. In such an example, marketing platform 230 may anonymize information associated with clothing retailers B-E. Marketing platform 230 may delete the number of store visits per day (e.g., 1) associated with clothing retailer D from the anonymous performance information since the number of store visits for clothing retailer D does not correlate (e.g., is an outlier) with the number of store visits associated with clothing retailers A-C and E.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

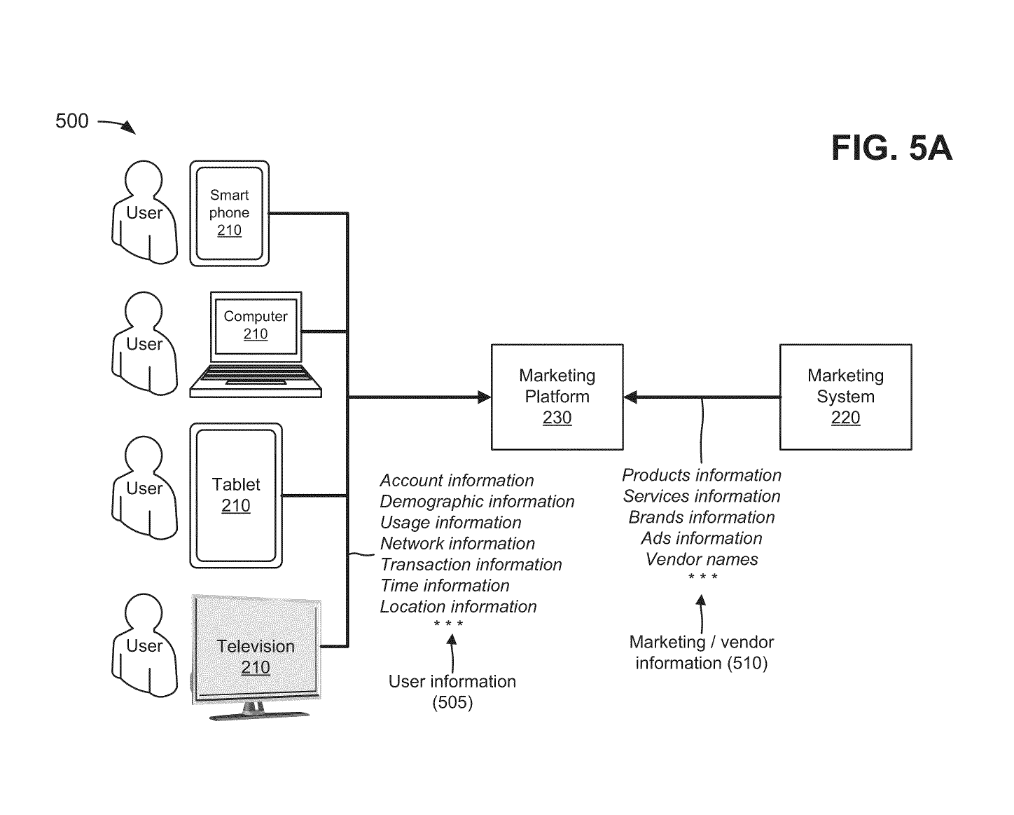

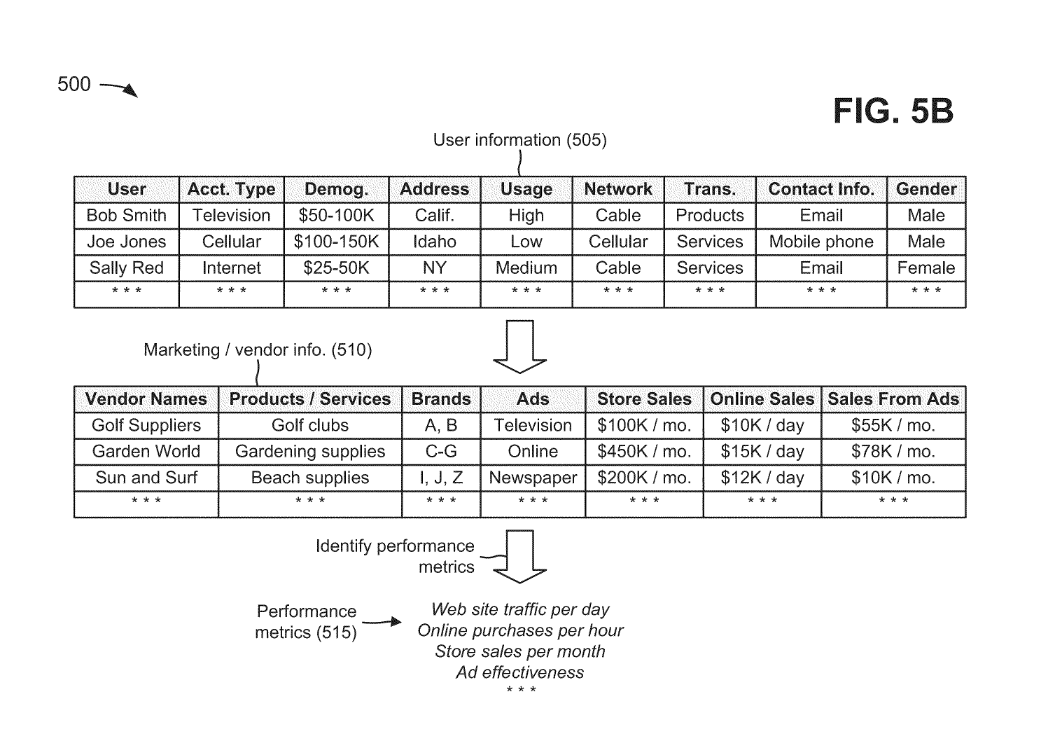

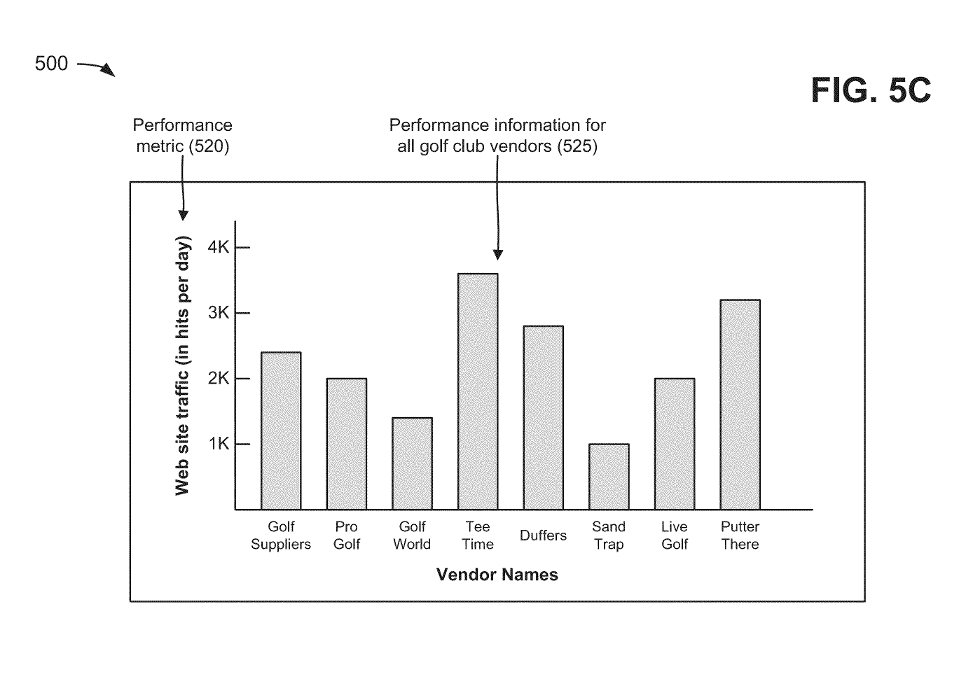

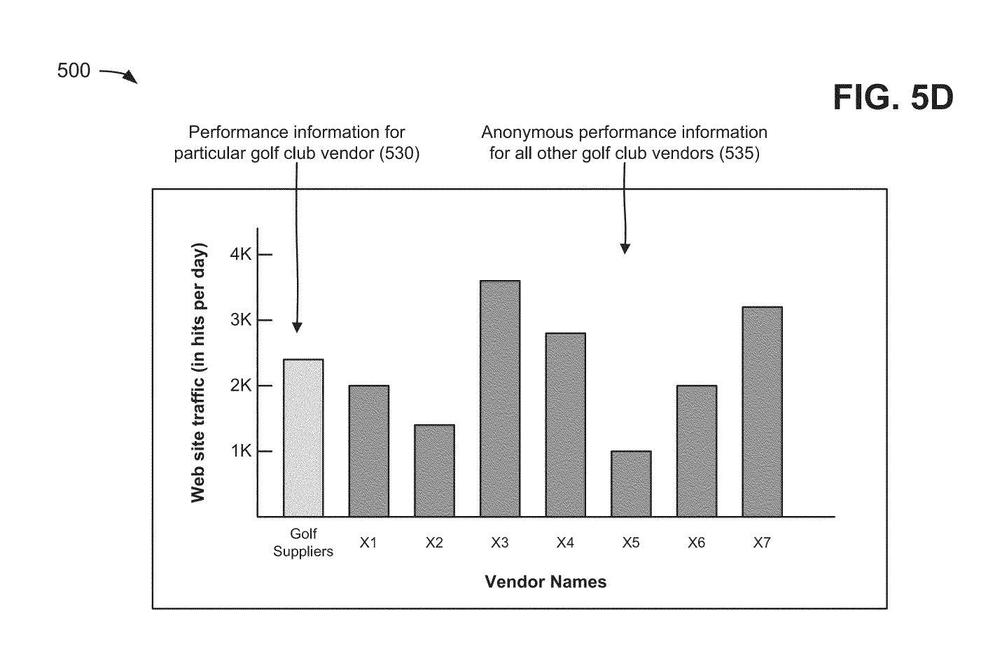

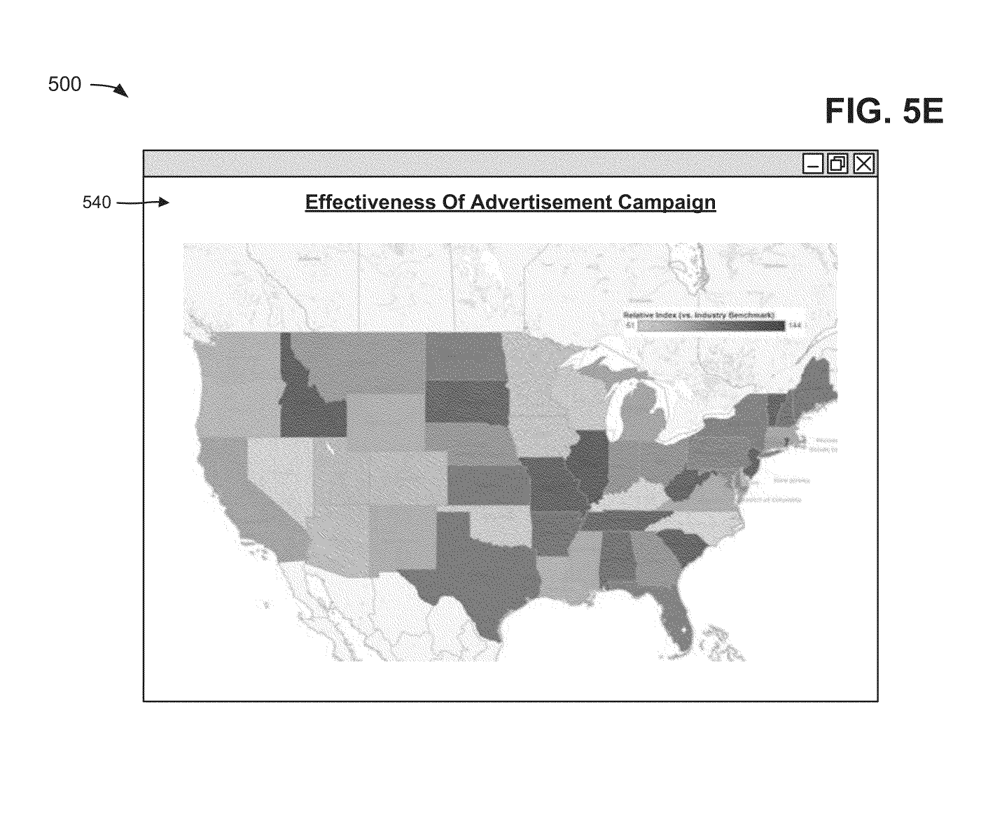

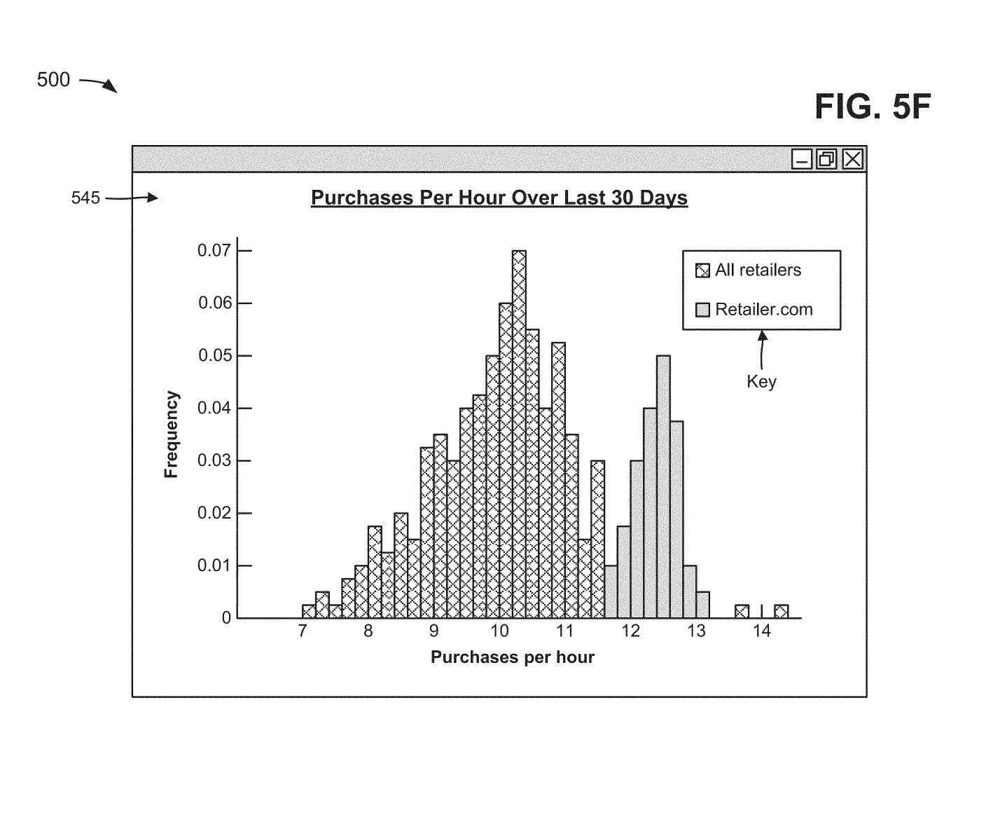

FIGS. 5A-5F are diagrams of an example 500 relating to example process 400 shown in FIGS. 4A and 4B. With reference to FIG. 5A, assume that users are associated with a variety of user devices 210 (e.g., smart phones, computers, tablets, televisions, etc.) that provide user information 505. User information 505 may include information associated with user devices 210 and the users (e.g., account information, demographic information, etc.); network information (e.g., information associated with network resources of network 250 utilized by user devices 210); network usage information associated with user devices 210; content accessed by user devices 210; transactions associated with user devices 210; clickstream information associated with user devices 210; location information associated with user devices 210; time information associated with user devices 210; etc. User devices 210 may provide user information 505 to marketing platform 230, and marketing platform 230 may receive user information 505.

As further shown in FIG. 5A, marketing system 220 may provide marketing/vendor information 510 that includes information associated with products and/or services offered by vendors and to be marketed to the users; advertisements for the products and/or the services offered by the vendors; brands information; marketing campaign information; user information 505 received by the vendors via interactions between the vendors and the users; vendor names; etc. Marketing system 220 may provide marketing/vendor information 510 to marketing platform 230, and marketing platform 230 may receive marketing/vendor information 510.

As shown in FIG. 5B, marketing platform 230 may store user information 505 in a data structure (e.g., a tree, a table, a list, a database, etc.) that includes a user field, an account type field, a demographic field, an address field, a usage field, a network field, a transaction field, a contact information field, a gender field, and multiple entries associated with the fields. The user field may include information identifying the users of user devices 210, such as, for example, names, user identifiers, user account numbers, etc. The account type field may include information identifying types of accounts associated with the users, such as, for example, a television service account, a cellular service account, an Internet service account, etc. The demographic field may include information identifying demographics of the users, such as, for example, income levels of the users, education levels of the users, age, race, etc. The address field may include information identifying home addresses of the users. The usage field may include information identifying network usage by the users, such as, for example, high network usage, medium network usage, low network usage, bandwidth utilization, etc. The transaction field may include information identifying transactions performed by the users with user devices 210, such as, for example, transactions for products, services, etc. The contact information field may include information identifying contact information (e.g., email addresses, mobile phone numbers, home phone numbers, etc.) for the users. The gender field may include information identifying genders (e.g., male versus female) of the users.

As further shown in FIG. 5B, marketing platform 230 may store marketing/vendor information 510 in a data structure that includes a vendor names field, a products/services field, a brands field, an advertisements field, a store sales field, an online sales field, a sales from ads field, and multiple entries associated with the fields. The vendor names field may include information identifying vendors (e.g., Golf Suppliers, Garden World, Sun and Surf, etc.) that wish to sell products/services to users. The products/services field may include information identifying products/services that vendors wish to sell to users, such as, for example, golf clubs, gardening supplies, beach supplies, etc. The brands field may include information identifying brands associated with the products/services, such as, for example, brands A and B for the golf clubs, brands C-G for the gardening supplies, brands I, J, and Z for the beach supplies, etc. The advertisements field may include information identifying advertisements associated with the products/services, such as, for example, television advertisements for the golf clubs, online advertisements for the gardening supplies, mobile advertisements for the beach supplies, etc. that may be shown on television (e.g., via a STB), via an email message, via a short message service (SMS) message, etc. The store sales field may include information identifying sales made in stores operated by the vendors, such as, for example, $100K/month for Golf Suppliers, $450K/month for Garden World, $200K/month for Sun and Surf, etc. The online sales field may include information identifying sales made via web sites operated by the vendors, such as, for example, $10K/day for Golf Suppliers, $15K/day for Garden World, $12K/day for Sun and Surf, etc. The sales from ads field may include information identifying sales associated with advertisements of the vendors, such as, for example, $55K/month for Golf Suppliers, $78K/month for Garden World, $10K/month for Sun and Surf, etc.

Marketing platform 230 may identify performance metrics 515 based on user information 505 and/or marketing/vendor information 510, as further shown in FIG. 5B. For example, marketing platform 230 may identify web site traffic per a time period (e.g., hour, day, week, etc.), online purchases per a time period, store sales per a time period, advertisement effectiveness, visits to a store in a time period, etc. as performance metrics 515 associated with the vendors.

Assume that a particular vendor (e.g., Golf Suppliers) in a particular industry (e.g., golf club vendors) provides a request for a comparison of web site traffic (e.g., in hits per day) associated with Golf Suppliers and web site traffic associated with other golf club vendors. Further, assume that marketing platform 230 selects, based on the request, web site traffic for golf club vendors as a performance metric 520, from the identified performance metrics 515, as shown in FIG. 5C. Marketing platform 230 may determine performance information 525 for all of the golf club vendors based on user information 505 and/or marketing/vendor information 510. For example, as further shown in FIG. 5C, marketing platform 230 may determine web site traffic for golf club vendors, such as, Golf Suppliers, Pro Golf, Golf World, Tee Time, Duffers, Sand Trap, Live Golf, and Putter There.

As shown in FIG. 5D, marketing platform 230 may not anonymize performance information 530 for the particular golf club vendor (e.g., Golf Suppliers), and may anonymize performance information for the other golf club vendors to produce anonymous performance information 535. For example, marketing platform 230 may remove information identifying the other golf club vendors (e.g., the names of the other golf vendors), and may replace the removed information with fictitious information (e.g., fictitious names, such as X1, X2, etc.). Marketing platform 230 may store performance information 530 for Golf Suppliers and/or anonymous performance information 535 for the other golf club vendors. Marketing platform 230 may provide performance information 530 and anonymous performance information 535 for display to vendor device 240 associated with Golf Suppliers so that Golf Suppliers may compare its web site traffic with web site traffic of the other golf club vendors. For example, Golf Suppliers may determine, based on performance information 530 and anonymous performance information 535, that Golf Suppliers is receiving more web site traffic than the other golf club vendors, except for golf club vendors X3, X4, and X7.

Now assume that a particular vendor (e.g., a clothing retailer A) in a particular industry (e.g., clothing retailers) provides a request for information identifying an effectiveness of an advertisement campaign associated with clothing retailer A versus advertising campaigns in the particular industry. Further, assume that marketing platform 230 determines advertisement campaign effectiveness (e.g., as determined by sales for advertised clothes) for all of the clothing retailers based on user information 505 and/or marketing/vendor information 510. Marketing platform 230 may compare the advertisement campaign effectiveness for clothing retailer A with an advertisement campaign effectiveness benchmark (e.g., as determined for the particular industry) without divulging information identifying the clothing retailers. As shown in FIG. 5E, marketing platform 230 may provide the comparison for display to vendor device 240 associated with clothing retailer A, via a user interface 540. User interface 540 may depict a map of the United States of America with shading (e.g., with darker shading indicating more effectiveness) that indicates a relative effectiveness of the advertisement campaign associated with clothing retailer A in different states.

Now assume that a particular vendor (e.g., retailer.com) in a particular industry (e.g., retailers) provides a request for information identifying online purchases per hour (e.g., over the last thirty days) associated with retailer.com versus online purchases per hour for all of the other retailers in the particular industry. Further, assume that marketing platform 230 determines the online purchases per hour for all of the retailers based on user information 505 and/or marketing/vendor information 510. Marketing platform 230 may compare the online purchases per hour for retailer.com with the online purchases per hour for the other retailers without divulging information identifying the other retailers. As shown in FIG. 5F, marketing platform 230 may provide the comparison for display to vendor device 240 associated with retailer.com, via a user interface 545. User interface 545 may include a bar chart that depicts frequencies associated with online purchases per hour for retailer.com and frequencies associated with online purchases per hour for the other retailers.

As indicated above, FIGS. 5A-5F are provided merely as an example. Other examples are possible and may differ from what was described with regard to FIGS. 5A-5F.

Systems and/or methods described herein may provide a marketing platform that provides anonymous performance information related to peer vendors, and compares the anonymous performance information with actual performance information for a particular vendor. The systems and/or methods may ensure that information identifying the peer vendors of the particular vendor is protected and not shared with the particular vendor. The systems and/or methods may enable the particular vendor to determine how the particular vendor is performing in comparison with the peer vendors.

To the extent the aforementioned implementations collect, store, or employ personal information provided by individuals, it should be understood that such information shall be used in accordance with all applicable laws concerning protection of personal information. Additionally, the collection, storage, and use of such information may be subject to consent of the individual to such activity, for example, through “opt-in” or “opt-out” processes as may be appropriate for the situation and type of information. Storage and use of personal information may be in an appropriately secure manner reflective of the type of information, for example, through various encryption and anonymization techniques for particularly sensitive information.

The foregoing disclosure provides illustration and description, but is not intended to be exhaustive or to limit the implementations to the precise form disclosed. Modifications and variations are possible in light of the above disclosure or may be acquired from practice of the implementations.

A component is intended to be broadly construed as hardware, firmware, or a combination of hardware and software.

User interfaces may include graphical user interfaces (GUIs) and/or non-graphical user interfaces, such as text-based interfaces. The user interfaces may provide information to users via customized interfaces (e.g., proprietary interfaces) and/or other types of interfaces (e.g., browser-based interfaces, etc.). The user interfaces may receive user inputs via one or more input devices, may be user-configurable (e.g., a user may change the sizes of the user interfaces, information displayed in the user interfaces, color schemes used by the user interfaces, positions of text, images, icons, windows, etc., in the user interfaces, etc.), and/or may not be user-configurable. Information associated with the user interfaces may be selected and/or manipulated by a user (e.g., via a touch screen display, a mouse, a keyboard, a keypad, voice commands, etc.).

It will be apparent that systems and/or methods, as described herein, may be implemented in many different forms of hardware, firmware, and/or combinations of software and hardware in the implementations illustrated in the figures. The actual software code or specialized control hardware used to implement these systems and/or methods is not limiting of the implementations. Thus, the operation and behavior of the systems and/or methods were described without reference to the specific software code—it being understood that software and control hardware can be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Furthermore, as used herein, the term “set” is intended to include one or more items, and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

What is claimed is:

1. A method, comprising:
receiving, by a device, user information associated with users of user devices,
the user information including one or more of:
clickstream information associated with the user devices,
time information associated with the user devices,
location information associated with the user devices,
transaction information associated with the user devices, or
network information associated with the user devices;
identifying, by the device and based on the user information, a performance metric for a plurality of vendors of at least one of products or services;
determining, by the device, performance information for the plurality of vendors based on the identified performance metric and based on the user information;
anonymizing, by the device, the performance information for the plurality of vendors to produce anonymous performance information, without anonymizing the performance information for a particular vendor of the plurality of vendors; and
storing, by the device, the anonymous performance information and the performance information for the particular vendor.

2. The method of claim 1, further comprising:
providing, for display to a device associated with the particular vendor, the anonymous performance information and the performance information for the particular vendor.

3. The method of claim 1, further comprising:
receiving vendor information associated with the particular vendor,
the vendor information including at least one of:
information associated with sales of products or services offered by the particular vendor to the users,
advertisements for the products or the services offered by the particular vendor,
marketing campaign information associated with the particular vendor, or
information associated with interactions between the particular vendor and the users;
determining the performance information for the particular vendor based on the vendor information.

4. The method of claim 1, further comprising:
receiving vendor information associated with the plurality of vendors,
the vendor information including at least one of:
information associated with sales of products or services offered by the plurality of vendors to the users,
advertisements for the products or the services offered by the plurality of vendors,
marketing campaign information associated with the plurality of vendors, or
information associated with interactions between the plurality of vendors and the users;
determining the performance information for the plurality of vendors based on the vendor information, the user information, and the identified performance metric.

5. The method of claim 1, where anonymizing the performance information for the plurality of vendors comprises:
removing information identifying the plurality of vendors from the performance information.

6. The method of claim 1, where anonymizing the performance information for the plurality of vendors comprises:
utilizing a data anonymization technique to anonymize the performance information for the plurality of vendors,
the data anonymization technique including at least one of:
a data encryption technique,
a substitution technique,
a shuffling technique, or
a nulling out technique.

7. The method of claim 1, further comprising:
generating a user interface that compares the anonymous performance information and the performance information for the particular vendor; and
providing the user interface for display to a device associated with the particular vendor.

8. A system, comprising:
one or more devices to:
receive user information associated with users of user devices,
the user information including a plurality of:
clickstream information associated with the user devices,
time information associated with the user devices,
location information associated with the user devices,
transaction information associated with the user devices, or
network information associated with the user devices;
receive vendor information associated with a plurality of vendors;
identify a performance metric for the plurality of vendors based on the user information and the vendor information;
determine performance information for the plurality of vendors based on the identified performance metric, the user information, and the vendor information;
anonymize the performance information for the plurality of vendors to produce anonymous performance information, without anonymizing the performance information for a particular vendor of the plurality of vendors; and
store the anonymous performance information and the performance information for the particular vendor.

9. The system of claim 8, where the one or more devices are further to:
provide, for display to a device associated with the particular vendor, the anonymous performance information and the performance information for the particular vendor.

10. The system of claim 8, where the one or more devices are further to:
determine the performance information for the particular vendor based solely on the vendor information associated with the particular vendor.

11. The system of claim 8, where the vendor information includes a plurality of:
information associated with sales of products or services offered by the plurality of vendors to the users,
advertisements for the products or the services offered by the plurality of vendors,
marketing campaign information associated with the plurality of vendors, or
information associated with interactions between the plurality of vendors and the users.

12. The system of claim 8, where, when anonymizing the performance information for the plurality of vendors, the one or more devices are further to:
remove information that can be used to identify the plurality of vendors from the performance information.

13. The system of claim 8, where, when anonymizing the performance information for the plurality of vendors, the one or more devices are further to:
utilize a data anonymization technique to anonymize the performance information for the plurality of vendors,
the data anonymization technique including at least one of:
a data encryption technique,
a substitution technique,
a shuffling technique, or
a nulling out technique.

14. The system of claim 8, where the one or more devices are further to:
generate a user interface that visually presents the anonymous performance information and the performance information for the particular vendor; and
provide the user interface for display to a device associated with the particular vendor.

15. A computer-readable medium storing instructions, the instructions comprising:
one or more instructions that, when executed by one or more processors of a device, cause the one or more processors to:
receive user information associated with users of user devices;
receive vendor information associated with a plurality of vendors;
identify a performance metric for the plurality of vendors based on a request received from a particular vendor of the plurality of vendors;
determine performance information for the plurality of vendors based on the identified performance metric, the user information, and the vendor information;
anonymize the performance information for the plurality of vendors to produce anonymous performance information, without anonymizing the performance information for the particular vendor;
generate a user interface that visually depicts the anonymous performance information and the performance information for the particular vendor; and
provide the user interface to a device associated with the particular vendor.

16. The computer-readable medium of claim 15, where the user information includes one or more of:
clickstream information associated with the user devices,
time information associated with the user devices,
location information associated with the user devices,
transaction information associated with the user devices, or
network information associated with the user devices.

17. The computer-readable medium of claim 15, where the instructions further comprise:
one or more instructions that, when executed by the one or more processors, cause the one or more processors to:
determine the performance information for the particular vendor based solely on the vendor information associated with the particular vendor.

18. The computer-readable medium of claim 15, where the vendor information includes at least one of:
information associated with sales of products or services offered by the plurality of vendors to the users,
advertisements for the products or the services offered by the plurality of vendors,
marketing campaign information associated with the plurality of vendors, or
information associated with interactions between the plurality of vendors and the users.

19. The computer-readable medium of claim 15, where the one or more instructions to anonymize the performance information for the plurality of vendors further comprise:
one or more instructions that, when executed by the one or more processors, cause the one or more processors to:
remove information identifying the plurality of vendors from the performance information.

20. The computer-readable medium of claim 15, where the one or more instructions to anonymize the performance for the plurality of vendors further comprise:
one or more instructions that, when executed by the one or more processors, cause the one or more processors to:
utilize a data anonymization technique to anonymize the performance information for the plurality of vendors,
the data anonymization technique including at least one of:
a data encryption technique,
a substitution technique,
a shuffling technique, or
a nulling out technique.
